(19) United States
(12) Patent Application Publication
(10) Pub. No.: US 2004/0200077 A1
(43) Pub. Date: Oct. 14, 2004

(54) Blade module of electric clipper

(76) Inventors: Shu-Sian Liao, Taichung City (TW); Hung-Chang Liao, Taichung City (TW)

Correspondence Address: CHARLES E. BAXLEY, ESQUIRE, 59 John Street, Fifth Floor, New York, NY, 10038, US

(21) Appl. No.: 10/412,920

(22) Filed: Apr. 14, 2003

(51) Int. Cl. B26B 19/04

(52) U.S. Cl. 30/346.51; 30/346.53; 30/346.54; 30/350

(57) ABSTRACT

An improved shearing blade module of an electric clipper comprises an upper blade and a lower blade; the lower blade is fixed, and the upper blade is comprised of a swaying member capable of swaying sideway in the housing of the electric clipper, such that the blades of the upper and lower blades define the shearing action; the lower blade has a metallic main body, and a hard vacuum coated film is disposed on the surface of said main body; said upper blade has a main body with both volume and area smaller than those of the lower blade, and said main body is made of ceramics. Combining the excellent properties of the ceramic material and the hard multiplayer film, the blade module enhances the heat resistance, wear resistance, and sharpness of the blade sections of the upper and lower blades.

### BACKGROUND OF THE INVENTION

1. Field of the Invention

The present invention relates to an electric clipper, more particularly to an improved blade of an electric clipper, which is wear-resisting and not easy to deform.

2. Description of the Related Art

The structure of an electric clipper generally has a housing for holding, and the interior of the housing has a motor, a gear, and a swaying element, etc; the front end of the housing is a blade module, which is comprised of an upper blade and a lower blade. The lower blade is fixed and the upper blade is comprised of a swaying member that is controlled to move sideway quickly, such that the blades of the upper and lower blades define a shearing action and achieve the hair cutting function.

In the prior art, upper and lower blades generally have polished surfaces made of metal, which is wear-resisting and low heat-resisting. When the upper blade is rapidly swayed sideway that produces friction with the lower blade, heat is generated and the frictional surface may be worn out easily or even deformed. It affects the smoothness of moving the blades and shortens the life of the upper and lower blades.

Traditional blades of the upper and lower blades are usually not sharp enough or their sharpness cannot last long unless special treatments are taken place. When the two blades shear, hair cannot be cut instantly. Therefore the problem of pulling hairs arises, and the users may feel the pain of their hair being pulled by the electric clipper, which makes the use uncomfortable.

The cut hair may easily attach on the polished surface of the upper and lower blades made of metals, which may affect the smoothness of the swaying of the blades. Therefore, it is common for users to tap the clipper and remove the hair on the blade by vibration, but such improper tapping may deform the blade and make the clipper usable. Tapping is an inappropriate way of removing hair from the clipper. If the blade is rinsed by water, it may rust the upper and lower blades, and also cause accumulation of limescales on the blade, which may cause skin allergy to users or have the risk of cutting their skin. A more serious problem is that once the smoothness of moving the upper blade is affected, the swaying member and the entire internal components may be affected or damaged.

### SUMMARY OF THE INVENTION

The primary objective of the present invention is to provide an improved technical measure to overcome the shortcomings of the prior art such as the low wear resistance, low heat resistance, easy to deform, short life, insufficient sharpness of the blade, not lasting sharpness, easy to accumulate hairs, not suitable for rinsing, affecting the sanitation, and damaging components easily due to the rough movement of the blades. The present invention uses a hard vacuum coating on the surface of the lower blade and a ceramic lower blade to constitute the shearing tool of the electric clipper. Combining the excellent properties of the ceramic material and the hard multi-layer film, the blade module is heat-resisting, wear-resisting, having no scrapes on the frictional surfaces, enhancing the shearing sharpness of the upper and lower blades, and instantly cutting the hair without pulling on the hair. The cut hair will not attach on the blade easily and can remove the remained hair easily to keep the cutting tool clean and thus improving hygiene and safety. The present invention also keeps the shearing action of the blades smooth, and thus reduces damages to the electric clipper due to the jam of components of the electric clipper.

The technical measures taken to solve the problem of the prior art are described as follows:

The lower blade of the present invention is a metal member having a hard vacuum coated film on its surface, and the upper blade is made of ceramics.

### BRIEF DESCRIPTION OF THE DRAWINGS

Other features and advantages of the present invention will become apparent in the following detailed description of the preferred embodiments with reference to the accompanying drawings, in which:

FIG. 1 is a perspective diagram of the disassembled parts of the upper and lower blades of the present invention.

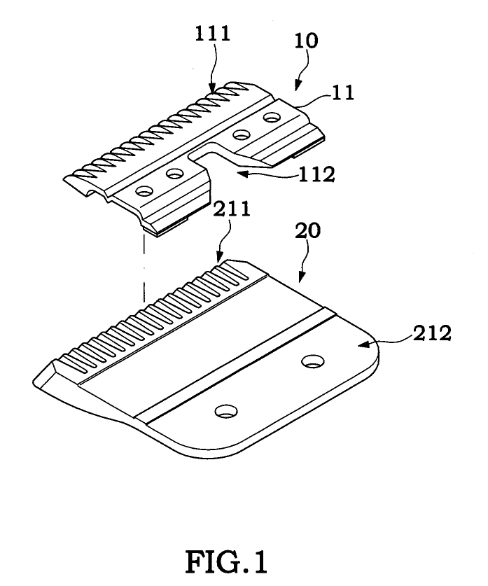

FIG. 2 is a perspective diagram of the assembled structure of the upper and lower blades of the present invention.

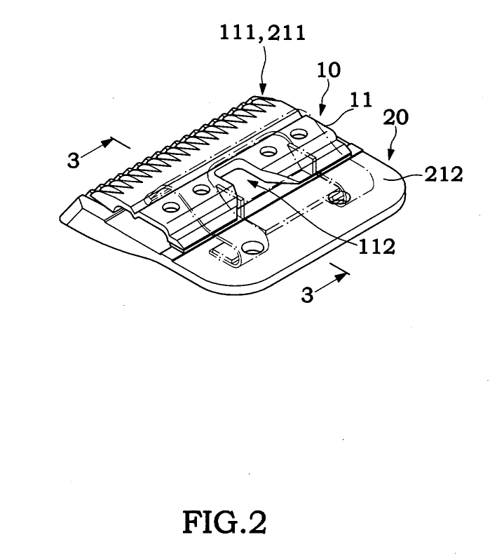

FIG. 3 is a cross-sectional diagram of the section 3-3 of FIG. 2.

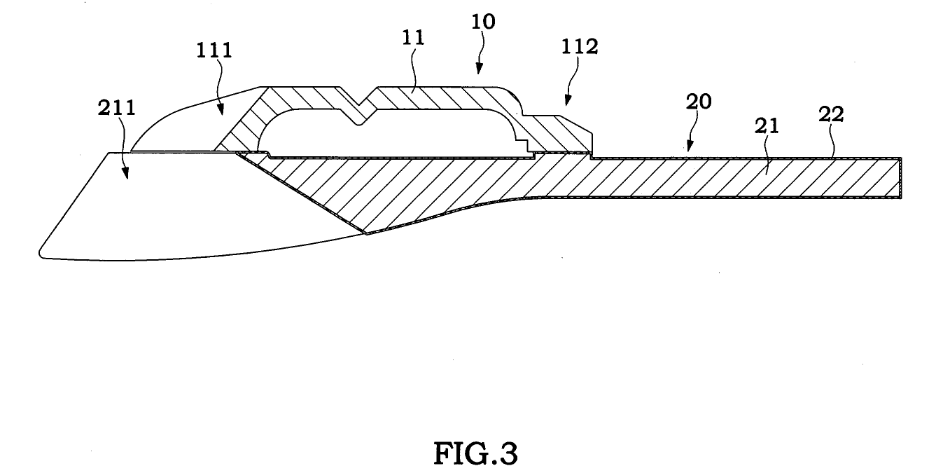

### DETAILED DESCRIPTION OF THE PREFERRED EMBODIMENTS

The present invention discloses a blade module of an electric clipper, which is used as a clipper for people or pets. For convenience, “hair” is used as the object cut down by such electric clipper.

The blade module of an electric clipper in accordance with the present invention comprises an upper blade 10 and a lower blade 20; the lower blade 20 is fixed, and the swaying member of the upper blade (as described in the prior art) disposed in a housing of the electric clipper controls and quickly moves sideway such that the blade sections 111, 112 of the upper and lower blades 10, 20 define the shearing action and achieve the purpose of cutting hairs.

The lower blade 20 has a metal main body 21; the front edge of the main body 21 is a blade section 211, and the rear end of the main body 21 is a coupling section 212 for coupling with an electric cutting tool (not shown in the Figure), and a hard vacuum coated film 22 is coated on the entire outer surface of the main body. Such hard vacuum coated film 22 could be a multi-layer film made of four materials: Ti, TiN, TiCN, and TiO. The brief physical properties of such hard vacuum coated film 22 includes a Vickers hardness (Hv) of about 800˜2200, a friction coefficient (VSNi) of about 0.4, a melting point (° C.) of about 2950, a density (g/cm3) of about 5.44, a Young's coefficient (104 kg f/m m2) of about 2.6˜6.2, a thermal conductivity coefficient (Cal/° C.sec.cm) of about 0.05˜0.07, a coefficient of expansion (10/° C.) of about 9.2, an oxidation temperature (° C.) of about 500, and a surface roughness (Ra . . . μm) of about 0.15. The hard vacuum coated film 22 is used such that the heat resistance and wear resistance of the lower blade are improved, and have a surface color different from that of the metallic main body.

The upper blade 10 is a blade having a volume and an area smaller than those of the lower blade 20 and has a main body made of ceramics. The blade section 111 is disposed at the front end of the main body 11 and a link section 112 coupled to a swaying member is disposed at the rear end. The upper blade 10 made of ceramics has the advantages such as high hardness, high wear resistance, high heat resistance, light in weight, rustproof, easy to rinse, and special texture. The blade section 111 is sharp and such sharpness can last long. The upper blade 10 could also be a main body made of iron, and the whole surface is plated with chromium treatment to improve the hardness, wear resistance, and heat resistance of the blade.

Compared with the traditional blade module, the present invention has the following advantages:

1. The present invention uses a lower blade 20 having a hard vacuum coated film 22 on its surface and a ceramic upper blade 20 to form an electric clipper. Combining the excellent properties of the ceramic material and hard multi-layer film, the blade module could improve its heat resistance and wear resistance, have no scrapes on the frictional surface, keep the back and forth movement of the upper blade 10 smooth, solve the problems of the prior art that the surface is damaged or deformed due to the friction, and also shortening the life of use.

2. Further, the upper blade 10 made of ceramics has a sharper blade section 111 and a sharpness lasting longer, and is capable of cutting hair instantly while shearing with the blade section 211 without pulling the hair. Therefore, the user will not have the pain of having their hair pulled by the electric clipper. The present invention can enhance the comfort and safety.

3. Regardless of the whole or just the blade section, both upper and lower blades 10, 20 have the advantages of smooth surface and low friction coefficient. Therefore, the cut hair will not attach onto the blade section 111, 211, and can be thrown away as the upper blade 10 moves rapidly sideway. It thus can solve the problem of the cut hair being jammed in the blade sections 111, 211. Alternatively, after the cutter is used, the user just needs to swing or blow the blade section 111, 211 gently to remove the remained hair, keep the cutter clean, or improve the hygiene and safety.

4. The upper and lower blades 10, 20 have the advantages of not being oxidized or rusted easily, and thus the blade section can be cleaned by water or rust-resisting oil. It does not need extra maintenance to keep the cutting function or sharpness for a long time.

5. Since the upper and lower blades 10. 20 can shear smoothly for a long time and keep the operation of internal components in the electric clipper to eliminate the problem of damaging the internal driving components due to the friction produced by the upper and lower blades 10, 20.

6. The upper and lower blades 10, 20 are made of different materials, and thus having surfaces of different colors, such that the appearance and visual effect of the present invention are improved over the prior-art cutter.

What is claimed is:

1. A blade module of electric clipper, comprising:
an upper blade, being a metal blade and having an outer surface with a hard vacuum coated film; and
a lower blade, being a blade made of a ceramic material.

2. The blade module of electric clipper of claim 1, wherein said hard vacuum coated film is a titanium (Ti) coating.

3. The blade module of electric clipper of claim 1, wherein said hard vacuum coated film is a titanium nitride (TiN) coating.

4. The blade module of electric clipper of claim 1, wherein said hard vacuum coated film is a carbide (TiN) coating.

5. The blade module of electric clipper of claim 1, wherein said hard vacuum coated film is a titanium oxide (TiO) coating.

6. The blade module of electric clipper of claim 1, wherein said hard vacuum coated film has a Vickers hardness (Hv) of about 800˜2200 Hv.

7. The blade module of electric clipper of claim 1, wherein said hard vacuum coated film has a friction coefficient (VSNi) of about 0.4.

8. The blade module of electric clipper of claim 1, wherein said hard vacuum coated film has a melting point (° C.) of about 2950.

9. The blade module of electric clipper of claim 1, wherein said hard vacuum coated film has a density (g/cm3) of about 5.44.

10. The blade module of electric clipper of claim 1, wherein said hard vacuum coated film has a Young's coefficient (104 kg f/m m2) of about 2.6˜6.2.

11. The blade module of electric clipper of claim 1, wherein said hard vacuum coated film has a thermal conductivity coefficient (Cal/° C.sec.cm) of about 0.05˜0.07.

12. The blade module of electric clipper of claim 1, wherein said hard vacuum coated film has a coefficient of expansion (10/° C.) of about 9.2.

13. The blade module of electric clipper of claim 1, wherein said hard vacuum coated film has an oxidation temperature (° C.) of about 500.

14. The blade module of electric clipper of claim 1, wherein said hard vacuum coated film has a surface roughness (Ra . . . μm) of about 0.15.

15. The blade module of electric clipper of claim 1, wherein said upper blade is made of iron and its surface is plated with chromium.

16. The blade module of electric clipper of claim 1, wherein said upper and lower blades have surfaces of different colors.
